(19) United States
(12) Patent Application Publication
(10) Pub. No.: US 2025/0266884 A1
(43) Pub. Date: Aug. 21, 2025

(54) CHANNEL STATE INFORMATION FEEDBACK METHOD AND APPARATUS

(71) Applicant: ELECTRONICS AND TELECOMMUNICATIONS RESEARCH INSTITUTE, Daejeon (KR)

(72) Inventors: An Seok LEE, Daejeon (KR); Yong Jin Kwon, Daejeon (KR); Seung Jae Bahng, Daejeon (KR); Young joon Yoon, Daejeon (KR); Heesoo Lee, Daejeon (KR); Yun Joo Kim, Daejeon (KR); Hyun Seo Park, Daejeon (KR); Jung Bo Son, Daejeon (KR); Yu Ro Lee, Daejeon (KR)

(21) Appl. No.: 19/057,703

(22) Filed: Feb. 19, 2025

(30) Foreign Application Priority Data
Feb. 19, 2024 (KR) 10-2024-0023689

(51) Int. Cl. H04B 7/06; H04L 5/00; H04L 41/16

(52) U.S. Cl. CPC H04B 7/0626; H04L 5/0048; H04L 41/16

(57) ABSTRACT

A method of a terminal may comprise: receiving a channel state information (CSI)-reference signal (RS) from a base station; estimating source CSI between the base station and the terminal based on the CSI-RS; inputting the source CSI into an artificial intelligence (AI)/machine learning (ML) model included in the terminal to acquire original CSI of the source CSI; and performing a feedback procedure for the original CSI using an interoperable CSI feedback method between the base station and the terminal.

### CROSS-REFERENCE TO RELATED APPLICATIONS

This application claims priority to Korean Patent Application No. 10-2024-0023689, filed on Feb. 19, 2024, with the Korean Intellectual Property Office (KIPO), the entire contents of which are hereby incorporated by reference.

### BACKGROUND

### 1. Technical Field

The present disclosure relates to a channel state information feedback technique, and more particularly, to a channel state information feedback technique using an artificial intelligence (AI)/machine learning (ML) model.

### 2. Related Art

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHZ. In other words, the 5G communication network can support both a FR1 and/or FR2 band. Compared to the LTE communication network, the 5G communication network can support various communication services and scenarios.

In order to perform data transmission and reception between a transmitter (e.g. base station) and a receiver (e.g. terminal), the base station may acquire channel state information between the base station and the terminal from the terminal. The base station may receive the channel state information measured by the terminal through a channel state reporting procedure. When the terminal performs the channel state reporting procedure and the channel state information is represented with high precision, overhead may increase.

To enable the terminal to report channel state information to the base station with high accuracy without increasing overhead, a channel state reporting procedure using an AI/ML model may be considered. The AI/ML model may be classified into a one-sided AI/ML model and a two-sided AI/ML model. The two-sided AI/ML model may refer to a case in which the AI/ML model is installed at both the terminal and the base station. The one-sided AI/ML model may refer to a case in which the AI/ML model is installed at either the terminal or the base station.

The two-sided AI/ML model may cause the following issues. In the two-sided AI/ML model, the terminal may train the AI/ML model and perform inference based on the AI/ML model. To ensure consistency between the AI/ML model parts installed at the terminal and the base station, a signaling procedure between the terminal and the base station may be required. In order to apply a one-sided AI/ML model instead of the two-sided AI/ML model, a training procedure of the AI/ML model, a data processing procedure for managing the AI/ML model, or an inference procedure based on the AI/ML model may need to be defined.

### SUMMARY

The present disclosure for resolving the above-described problems is directed to providing a method and an apparatus for channel state information feedback using an AI/ML model.

A method of a terminal, according to exemplary embodiments of the present disclosure, may comprise: receiving a channel state information (CSI)-reference signal (RS) from a base station; estimating source CSI between the base station and the terminal based on the CSI-RS; inputting the source CSI into an artificial intelligence (AI)/machine learning (ML) model included in the terminal to acquire original CSI of the source CSI; and performing a feedback procedure for the original CSI using an interoperable CSI feedback method between the base station and the terminal.

The method may further comprise: before receiving the CSI-RS, transmitting identification information of one or more AI/ML models supported by the terminal to the base station; in response to the identification information, receiving, from the base station, configuration information for configuring an original CSI restoration AI/ML model that performs an original CSI restoration functionality in the terminal; and configuring the original CSI restoration AI/ML model among the one or more AI/ML models in the terminal according to the configuration information.

The performing of the feedback procedure for the original CSI may further comprise: determining a similarity between each of matrixes defined based on a codebook included in both the terminal and the base station and the original CSI; determining index information associated with a matrix corresponding to the original CSI based on the similarities; and transmitting the index information to the base station to feed back the original CSI.

The method may further comprise: before receiving the CSI-RS, transmitting a request for CSI transmission for data pair collection to the base station; in response to the request for CSI-RS transmission, periodically receiving one or more CSI-RSs for data pair collection from the base station; collecting one or more data samples based on the one or more CSI-RSs for data pair collection to acquire data pairs for training the AI/ML model; and training the AI/ML model based on the data pairs.

The method may further comprise: transmitting a request for CSI-RS transmission for performance evaluation of the AI/ML model to the base station; in response to the request for CSI-RS transmission, periodically receiving one or more CSI-RSs for performance evaluation from the base station; collecting one or more data samples based on the one or more CSI-RSs for performance evaluation to acquire data pairs for performance evaluation of the AI/ML model; and evaluating a performance of the AI/ML model based on the data pairs and reporting a performance evaluation result to the base station.

The method may further comprise: in response to the performance evaluation result, receiving, from the base station, indication information indicating whether to deactivate the AI/ML model; and determining whether to deactivate the AI/ML model according to the indication information.

A method of a base station, according to exemplary embodiments of the present disclosure, may comprise: transmitting a channel state information (CSI)-reference signal (RS) to a terminal; receiving, from the terminal, a feedback on original CSI generated by an artificial intelligence (AI)/machine learning (ML) model included in the terminal; performing an interoperable CSI decoding procedure on the feedback on the original CSI; and restoring the original CSI through the interoperable CSI decoding procedure.

The performing of the interoperable CSI decoding procedure may comprise: receiving index information associated with the original CSI included in the received feedback; and determining a matrix corresponding to the index information as CSI among matrixes defined based on a codebook commonly defined for the terminal and the base station.

The method may further comprise: before transmitting the CSI-RS, receiving, from the terminal, identification information of one or more AI/ML models supported by the terminal; and in response to the identification information, transmitting, to the terminal, configuration information for configuring an original CSI restoration AI/ML model that performs an original CSI restoration functionality in the terminal.

The method may further comprise: receiving, from the terminal, a request for CSI transmission for data pair collection; and in response to the request for CSI-RS transmission, periodically transmitting CSI-RSs for data pair collection to the terminal, wherein the data pairs are used to train the AI/ML model included in the terminal.

The method may further comprise: receiving, from the terminal, a request for CSI-RS transmission for performance evaluation of the AI/ML model included in the terminal; in response to the request for CSI-RS transmission, periodically transmitting one or more CSI-RSs for performance evaluation to the terminal; receiving, from the terminal, a performance evaluation result generated by the terminal based on the one or more CSI-RSs for performance evaluation; and determining whether to activate the AI/ML model based on the performance evaluation result.

A terminal, according to exemplary embodiments of the present disclosure, may comprise at least one processor, wherein the at least one processor may cause the terminal to perform: receiving a channel state information (CSI)-reference signal (RS) from a base station; estimating source CSI between the base station and the terminal based on the CSI-RS; inputting the source CSI into an artificial intelligence (AI)/machine learning (ML) model included in the terminal to acquire original CSI of the source CSI; and performing a feedback procedure for the original CSI using an interoperable CSI feedback method between the base station and the terminal.

The at least one processor may further cause the terminal to perform: before receiving the CSI-RS, transmitting identification information of one or more AI/ML models supported by the terminal to the base station; in response to the identification information, receiving, from the base station, configuration information for configuring an original CSI restoration AI/ML model that performs an original CSI restoration functionality in the terminal; and configuring the original CSI restoration AI/ML model among the one or more AI/ML models in the terminal according to the configuration information.

In the performing of the feedback procedure for the original CSI, the at least one processor may cause the terminal to perform: determining a similarity between each of matrixes defined based on a codebook included in both the terminal and the base station and the original CSI; determining index information associated with a matrix corresponding to the original CSI based on the similarities; and transmitting the index information to the base station to feed back the original CSI.

The at least one processor may further cause the terminal to perform: before receiving the CSI-RS, transmitting a request for CSI transmission for data pair collection to the base station; in response to the request for CSI-RS transmission, periodically receiving one or more CSI-RSs for data pair collection from the base station; collecting one or more data samples based on the one or more CSI-RSs for data pair collection to acquire data pairs for training the AI/ML model; and training the AI/ML model based on the data pairs.

The at least one processor may further cause the terminal to perform: transmitting a request for CSI-RS transmission for performance evaluation of the AI/ML model to the base station; in response to the request for CSI-RS transmission, periodically receiving one or more CSI-RSs for performance evaluation from the base station; collecting one or more data samples based on the one or more CSI-RSs for performance evaluation to acquire data pairs for performance evaluation of the AI/ML model; and evaluating a performance of the AI/ML model based on the data pairs and reporting a performance evaluation result to the base station.

The at least one processor may further cause the terminal to perform: in response to the performance evaluation result, receiving, from the base station, indication information indicating whether to deactivate the AI/ML model; and determining whether to deactivate the AI/ML model according to the indication information.

According to the present disclosure, a terminal may include an AI/ML model. The terminal may estimate source CSI based on a CSI-RS received from a base station. The terminal may input the source CSI into its AI/ML model to output adjusted CSI. The terminal may perform a feedback procedure for the adjusted CSI using a feedback method interoperable between the terminal and the base station. The base station may acquire the adjusted CSI through the above-described feedback procedure.

When the terminal feeds back the adjusted CSI using the AI/ML model through the above-described procedure, a two-sided AI/ML model that is included in both the terminal and the base station may not be used. Since a two-sided AI/ML model is not used, a signaling procedure for ensuring consistency between the AI/ML model parts included in the terminal and the base station can be omitted, and a problem of increased computational load may not occur at a node that does not include the AI/ML model.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a communication system that performs a channel estimation procedure.

FIG. 4 is a conceptual diagram illustrating exemplary embodiments of a communication system including an AI/ML model.

FIG. 5 is a conceptual diagram illustrating exemplary embodiments of a communication system including an AI/ML model.

FIG. 6 is a sequence chart illustrating exemplary embodiments of a procedure for configuring an AI/ML model.

FIG. 7 is a sequence chart illustrating exemplary embodiments of a procedure for training an AI/ML model.

FIG. 8 is a sequence chart illustrating exemplary embodiments of a CSI feedback procedure using a terminal-side AI/ML model.

FIG. 9 is a sequence chart illustrating exemplary embodiments of a procedure for configuring an AI/ML model.

FIG. 10 is a sequence chart illustrating exemplary embodiments of a procedure for training an AI/ML model.

FIG. 11 is a sequence chart illustrating exemplary embodiments of a CSI feedback procedure using a base station-side AI/ML model.

FIG. 12 is a sequence chart illustrating a first exemplary embodiment of a performance evaluation procedure for an AI/ML model.

FIG. 13 is a sequence chart illustrating a second exemplary embodiment of a performance evaluation procedure for an AI/ML model.

FIG. 14 is a sequence chart illustrating exemplary embodiments of a performance evaluation procedure for an AI/ML model.

FIG. 15 is a conceptual diagram illustrating exemplary embodiments of a CSI feedback procedure using additional CSI feedback.

FIG. 16A is a sequence chart illustrating exemplary embodiments of a CSI feedback procedure using additional CSI feedback.

FIG. 16B is a sequence chart illustrating exemplary embodiments of a CSI feedback procedure using additional CSI feedback.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

The names of frames proposed in the present disclosure may be generalized as a first frame, a second frame, a third frame, and the like. In the present disclosure, a ‘transmission time’ may refer to a start time and/or an end time (e.g. completion time) of frame transmission, and a ‘reception time’ may refer to a start time and/or an end time (e.g. completion time) of frame reception. The term ‘time’ may be interpreted as a ‘time point’ depending on a context.

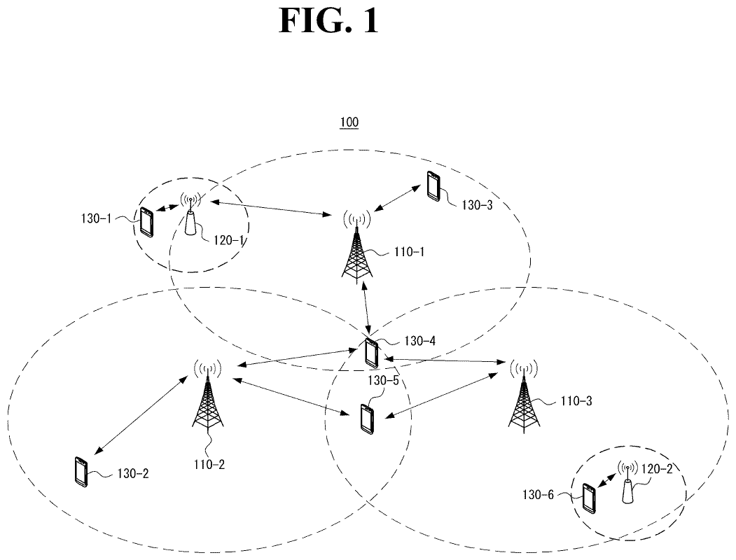

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

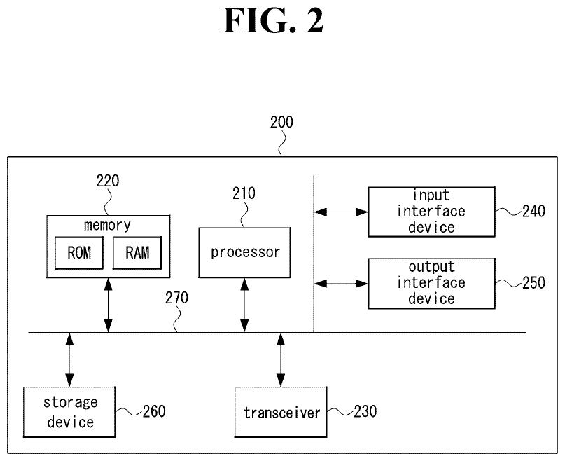

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

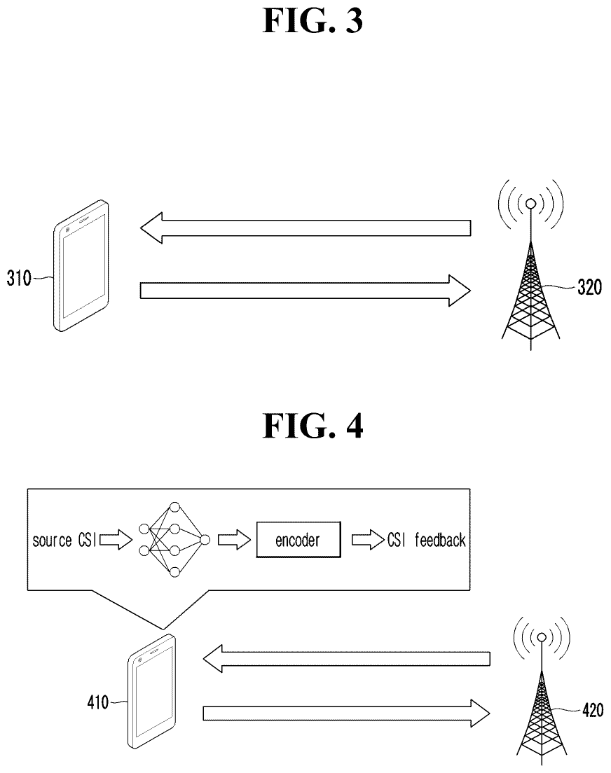

FIG. 3 is a conceptual diagram illustrating exemplary embodiments of a communication system that performs a channel estimation procedure.

Referring to FIG. 3, a mobile communication system may include a receiver (e.g. terminal 310) and a transmitter (e.g. base station 320). The base station 320 may perform data encoding, transmission power allocation, and beamforming to transmit data to the terminal 310. For the above-described operations, the base station 320 may acquire channel state information between the terminal 310 and the base station 320.

The base station 320 may not be able to directly observe a channel between the terminal 310 and the base station 320. The terminal 310 may estimate channel state information (CSI). A procedure in which the terminal 310 reports the measured CSI to the base station 320 may be required. The CSI may include a rank indicator (RI), a channel quality indicator (CQI), or a precoding matrix indicator (PMI).

CSI-reference signal (CSI-RS) may be considered for channel state estimation of the terminal 310. The base station 320 may periodically or aperiodically transmit CSI-RS to the terminal 310 for the channel state estimation of the terminal 310. The base station 320 may transmit resource allocation information for the CSI-RS to the terminal 310, which may then receive the CSI-RS accordingly. The terminal 310 may estimate CSI after receiving the CSI-RS. The terminal 310 may perform a procedure for reporting the estimated CSI to the base station 320. The procedure in which the terminal 310 feeds back the CSI to the base station 320 may be referred to as a CSI feedback procedure.

When the CSI feedback procedure is performed, if the CSI is represented in a high level of precision, the CSI feedback procedure may cause a large overhead. Information such as precoding matrix information for precoding at the base station 320 and information representing time-varying characteristics of the channel may cause a larger overhead as the representation precision increases. AI/ML techniques may be considered to enable the base station 320 to receive a CSI feedback with high accuracy while minimizing the transmission amount of information when the CSI feedback procedure is performed.

FIG. 4 is a conceptual diagram illustrating exemplary embodiments of a communication system including an AI/ML model.

Referring to FIG. 4, a communication system may include a terminal 410 and a base station 420. An AI/ML model may be included in the terminal 410. The AI/ML model may not be included in the base station 420. A case where the AI/ML model is included only in the terminal 410 or the base station 420 may be referred to as a one-sided model. A terminal-side (i.e. UE-sided) one-sided model and a base station-side (i.e. network-side) one-sided model may have a symmetrical relationship. Operations described in an exemplary embodiment of the terminal-side one-sided model in the present disclosure may be applicable to an exemplary embodiment of the base station-side one-sided model to the extent that no technical inconsistency arises.

The terminal 410 may acquire CSI estimated using the received CSI-RS. The acquired CSI may be referred to as source CSI. The AI/ML model included in the terminal 410 may be classified according to its functionality or purpose. The functionality of the AI/ML model included in the terminal 410 may include at least one of a functionality for predicting future CSI, a functionality for predicting CSI in a subband other than a subband in which the source CSI is estimated, or a functionality for restoring original CSI from the source CSI. An AI/ML model performing the functionality of predicting future CSI may be referred to as a future CSI prediction AI/ML model. An AI/ML model performing the functionality of predicting CSI in a subband other than a subband in which the source CSI is estimated may be referred to as a different-subband CSI prediction AI/ML model. An AI/ML model performing the functionality of restoring original CSI from the source CSI may be referred to as an original CSI restoration AI/ML model.

The terminal 410 may input the source CSI to the AI/ML model included in the terminal 410. The AI/ML model may output CSI adjusted according to the functionality of the AI/ML model. The terminal 410 may acquire the adjusted CSI through the AI/ML model. The terminal 410 may perform an interoperable CSI encoding method by inputting the adjusted CSI to an encoder. The interoperable CSI encoding method may refer to a method for compressing CSI through various CSI feedback schemes defined in the related arts. The interoperable CSI encoding method may mean a feedback method interpretable by the base station. Examples of the interoperable CSI encoding method may include a codebook-based method defined in the existing 3GPP technical specifications and a linear transformation-based method. The terminal 410 may perform an interoperable CSI feedback procedure with the base station 420 by using the interoperable CSI encoding method.

Depending on the functionality of the AI/ML model configured in the terminal 410, a required CSI feedback method may be restricted. The AI/ML model configured in the terminal 410 may include information regarding the required CSI feedback method as additional information in order to indicate the restricted CSI feedback method. The base station 420 may determine a CSI feedback method based on the additional information included in the AI/ML model configured or activated at the terminal 410. The determined CSI feedback method may be configured to the terminal 410 by the base station 420.

As examples of codebooks defined in the existing 3GPP technical specifications, a Type 1 codebook, a Type 2 codebook, an enhanced Type 2 codebook, an enhanced Type II port selection codebook, and a further enhanced Type II port selection codebook may exist. A CSI feedback method using a codebook may be as follows. The terminal 410 may generate a CSI feedback for a unit CSI element or an entire CSI element, and may transmit the generated CSI feedback to the base station 420. The generation of the CSI feedback may be performed by using a reference index or a codeword of a CSI element that is closest to the unit CSI element or the entire CSI element among CSI elements defined by the codebook. The unit CSI element may refer to a CSI element in a specific subband or a specific time duration. When the CSI feedback method using the codebook is performed by the terminal 410, the base station 420 may acquire the reference index of the CSI element from the CSI feedback received from the terminal 410. The base station 420 may generate received CSI using CSI corresponding to the reference index of the CSI element.

A CSI feedback method based on linear transformation may be as follows. The terminal 410 may perform dimensional transformation for each unit CSI or for entire CSI. The dimensional transformation may be performed using a linear transformation matrix. After performing the dimensional transformation, the terminal 410 may quantize the transformed information for all or part of the CSI and may generate a CSI feedback. The terminal 410 may transmit the generated CSI feedback to the base station 420. The base station 420 may perform inverse quantization and inverse linear transformation operations using the received CSI feedback. The base station 420 may generate received CSI through the inverse quantization and inverse linear transformation. The matrix used for the linear transformation may be configured by the base station 420 to the terminal 410 through higher layer signaling. Alternatively, the matrix used for the linear transformation may be reported by the terminal 410 to the base station 420 through higher layer signaling.

In the present disclosure, the operations described in the exemplary embodiment using a terminal-side or base station-side one-sided model may be applied to an exemplary embodiment of a two-sided AI/ML model to the extent that no technical inconsistency arises.

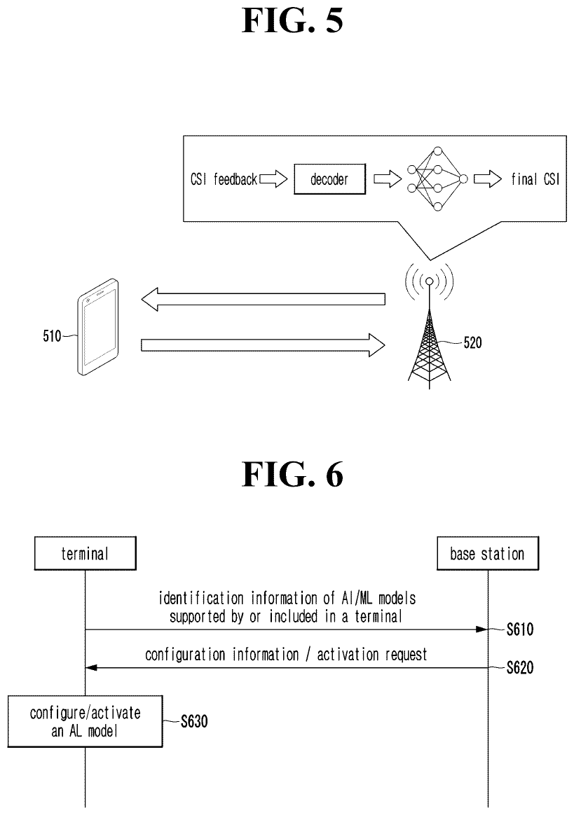

FIG. 5 is a conceptual diagram illustrating exemplary embodiments of a communication system including an AI/ML model.

Referring to FIG. 5, a communication system may include a terminal 510 and a base station 520. An AI/ML model may be included in the base station 520. The AI/ML model may not be included in the terminal 510.

The base station 520 may acquire feedback CSI through an interoperable CSI feedback procedure performed by the terminal 510. The feedback CSI may be received at the base station 520 in a form that is interpretable by the base station 520. Depending on the functionality of the AI/ML model configured in the base station 520, a required CSI feedback method may be restricted. The AI/ML model configured in the base station 520 may include, as additional information, information on the required CSI feedback method in order to indicate the corresponding CSI feedback method. The base station 520 may determine a CSI feedback method based on the above-described additional information. The base station 520 may configure the determined CSI feedback method to the terminal 510.

The AI/ML model included in the base station 520 may be classified according to a functionality or purpose. The functionality of the AI/ML model included in the base station 520 may include at least one of a functionality for predicting future CSI, a functionality for predicting CSI in a subband other than a subband in which source CSI is estimated, or a functionality for restoring original CSI from the source CSI.

The base station 520 may input the feedback CSI to a decoder included in the base station 520. The base station 520 may perform an interoperable CSI decoding procedure by inputting the feedback CSI to the decoder. The base station 520 may input the decoded feedback CSI (hereinafter referred to as ‘received CSI’) to the AI/ML model included in the base station 520. The AI/ML model to which the received CSI is input may output final CSI. The base station 520 may acquire the final CSI through the AI/ML model.

FIG. 6 is a sequence chart illustrating exemplary embodiments of a procedure for configuring an AI/ML model.

Referring to FIG. 6, a terminal may transmit identification information of AI/ML models supported by or included in the terminal to a base station (S610). The above-described identification information may include information on scenarios or regions to which the AI/ML models are applied (hereinafter referred to as ‘scenario/region information’). The above-described identification information may include information indicating CSI feedback method(s) limited by the AI/ML models. The information indicating the CSI feedback method(s) may include configuration information of a CSI feedback message (e.g. length information of the message). The configuration information of the CSI feedback message may be determined in advance for each AI/ML model. Alternatively, the configuration information of the CSI feedback message may be configured when the base station configures CSI reporting for the terminal. In a two-sided model including AI/ML model parts in both the terminal and the base station, the above-described identification information may include information indicating whether the AI/ML model parts included in the terminal and the base station are interoperable.

When the base station receives the above-described identification information, the base station may determine whether each AI/ML model supported by or included in the terminal is applicable to communication between the terminal and the base station based on a scenario or region to which the terminal currently belongs. The base station may transmit configuration information for configuring a determined AI/ML model in the terminal or an activation request for activating the determined AI/ML model to the terminal (S620). The above-described configuration information may be configuration information for configuring a future CSI prediction AI/ML model in the terminal, configuration information for configuring a different-subband CSI prediction AI/ML model in the terminal, or configuration information for configuring an original CSI restoration AI/ML model in the terminal. The above-described configuration information may include information indicating a CSI feedback method corresponding to the determined AI/ML model.

The terminal may configure the AI/ML model in the terminal or activate the AI/ML model included in the terminal in response to the received configuration information or activation request (S630).

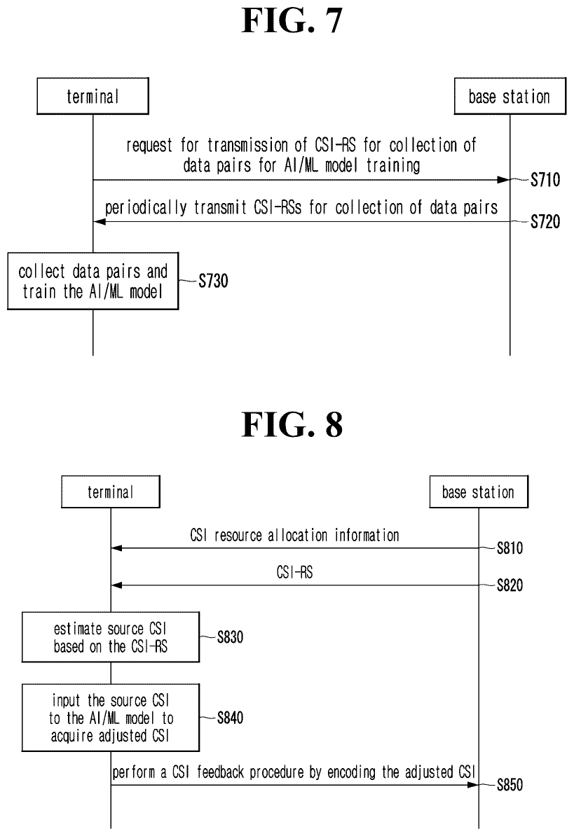

The procedures illustrated in FIG. 6 and FIG. 7 may be performed before the procedure illustrated in FIG. 8 is started. In the exemplary embodiments illustrated in FIG. 6 and FIG. 7, a terminal-side one-sided model may be assumed.

FIG. 7 is a sequence chart illustrating exemplary embodiments of a procedure for training an AI/ML model.

Referring to FIG. 7, the terminal may initiate a procedure for collecting data pairs for training the AI/ML model configured in the terminal.

The terminal may transmit a CSI-RS transmission request for collecting data pairs to the base station (S710). The above-described CSI-RS transmission request may include at least one of antenna configuration information of the terminal, the number of data samples required for training the AI/ML model, or a data sample period.

The data pair may vary depending on the functionality performed by the AI/ML model included in the terminal. The data pair may have a form in which input data and target data are paired. In a case where the AI/ML model included in the terminal performs a functionality of predicting future CSI, the data pair required for training may include both source CSI at a current time point and CSI at a target future time point. In a case where the AI/ML model included in the terminal performs a functionality of predicting CSI in a target subband different from a subband in which source CSI is estimated, the data pair required for training may include both the source CSI and CSI in the target subband. In a case where the AI/ML model included in the terminal performs a functionality of restoring original CSI, the data pair required for training may include both source CSI and original CSI.

When the base station receives the above-described request, the base station may transmit resource allocation information for transmitting and receiving CSI-RS for data pair collection to the terminal. After transmitting the resource allocation information, the base station may transmit the scenario/region information. The base station may periodically or aperiodically transmit CSI-RSs for data pair collection to the terminal (S720).

The terminal may collect one or more data samples based on the received CSI-RSs for data pair collection. The terminal may acquire data pairs required for training the AI/ML model based on the collected data samples (S730). The terminal may train the AI/ML model configured in the terminal using the acquired data pairs (S730).

The AI/ML model included in the terminal may perform a noise reduction functionality as an additional functionality. To perform the noise reduction functionality, high-resolution CSI may be required by the AI/ML model. The high-resolution CSI may refer to CSI estimated at many resource elements located on a resource grid. In order for the terminal to acquire the high-resolution CSI, transmission of high-density CSI-RS may be required. The transmission of high-density CSI-RS may mean that the CSI-RS is transmitted on more resource elements. The terminal may receive the high-density CSI-RS and acquire both target CSI and high-resolution target CSI.

For training the AI/ML model that performs prediction of CSI at a future time point, the terminal may acquire past CSI as input data. For training the AI/ML model that performs prediction of CSI at a future time point, data pairs including both past CSI and CSI at the current time point may be acquired by the terminal. The past CSI data samples may be one or more.

FIG. 8 is a sequence chart illustrating exemplary embodiments of a CSI feedback procedure using a terminal-side AI/ML model.

Referring to FIG. 8, the base station may transmit CSI-RS resource allocation information to the terminal (S810). The base station may transmit CSI feedback configuration information to the terminal. The CSI feedback configuration information may include length information of a CSI feedback message. When the length of a CSI feedback message is predetermined for each AI/ML model, the operation of the base station transmitting the CSI feedback configuration information to the terminal may be omitted. The base station may transmit CSI-RSs to the terminal after transmitting the CSI-RS resource allocation information to the terminal or after transmitting the CSI feedback configuration information (S820).

The terminal may receive CSI-RSs from the base station. The terminal may acquire source CSI based on the received CSI-RSs (S830). The terminal may input the source CSI to the trained AI/ML model and acquire adjusted CSI (S840). The adjusted CSI may vary depending on the functionality performed by the AI/ML model. The adjusted CSI may be one of CSI at a future time point after a time point at which the source CSI is estimated, CSI in a subband different from the subband in which the source CSI is estimated, CSI in a subband wider than the subband in which the source CSI is estimated, or original CSI of the source CSI.

The terminal may input the adjusted CSI to an encoder and perform an interoperable CSI encoding procedure. The terminal may perform interoperable CSI feedback through the interoperable CSI encoding procedure. The terminal may acquire CSI from the encoder. The terminal may feed back the CSI acquired from the encoder to the base station. The terminal may perform CSI feedback by encoding the adjusted CSI through the above-described series of procedures (S850). The interoperable CSI feedback may be one of a CSI feedback based on a codebook or a CSI feedback based on a linear transformation.

The feedback based on a codebook may be as follows. The terminal and the base station may include the same codebook. One or more precoding matrixes may be predefined in the codebook. The terminal may compare the adjusted CSI with one or more precoding matrixes defined in the codebook and determine a similarity between each precoding matrix and the adjusted CSI. The similarity may be determined through an inner product operation between vectors. The terminal may determine a precoding matrix corresponding to the adjusted CSI based on the above-described similarities. The terminal may determine an index (e.g. PMI) associated with the determined precoding matrix. The terminal may transmit the PMI to the base station. The base station may determine a precoding matrix corresponding to the index based on the PMI received from the terminal. The base station may restore CSI based on the precoding matrix. The restored CSI may be referred to as received CSI.

The CSI feedback based on linear transformation may be as follows. The terminal may perform a linear transformation on the adjusted CSI using a linear transformation matrix. The linear transformation matrix may be configured by the base station to the terminal. The dimension of the adjusted CSI may be reduced through the linear transformation. The terminal may perform quantization on the CSI that has undergone the linear transformation. The data size of the CSI may be reduced through the quantization. The terminal may feed back the CSI, the data size of which has been reduced through the quantization, to the base station. The base station may perform inverse quantization on the received feedback. The base station may perform inverse linear transformation on the inverse-quantized feedback. The linear transformation matrix used for the inverse linear transformation may be reported from the terminal to the base station. The base station may acquire CSI through the inverse linear transformation. The acquired CSI may be referred to as received CSI.

When the terminal-side one-sided model and the codebook-based feedback method are assumed, operations of the base station may be as follows. The base station may receive a feedback of the adjusted CSI from the terminal. The base station may perform an interoperable decoding procedure on the feedback of the adjusted CSI. The interoperable decoding procedure may be as follows. The base station may receive information on an index associated with the adjusted CSI included in the received feedback. The base station may determine a matrix corresponding to the index among matrixes defined based on the codebook commonly defined between the terminal and the base station, as the CSI. The base station may restore the adjusted CSI through the interoperable CSI decoding procedure.

When the terminal-side one-sided model and the linear transformation-based feedback method are assumed, operations of the base station may be as follows. The base station may receive a feedback of the adjusted CSI from the terminal. The base station may perform an interoperable decoding procedure on the feedback of the adjusted CSI. The interoperable decoding procedure may be as follows. The base station may perform inverse quantization on the feedback of the adjusted CSI. The base station may perform inverse linear transformation on the inverse-quantized feedback. The base station may acquire received CSI through the inverse linear transformation.

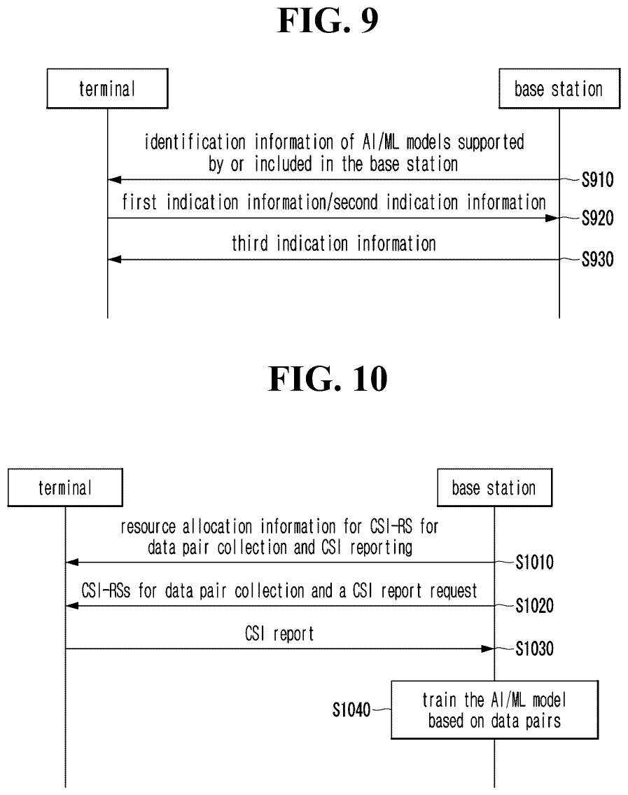

FIG. 9 is a sequence chart illustrating exemplary embodiments of a procedure for configuring an AI/ML model.

Referring to FIG. 9, the base station may transmit identification information of AI/ML models supported by or included in the base station to the terminal (S910). The base station may identify whether a CSI feedback method configured in the terminal matches each of the AI/ML models supported by or included in the base station through the transmission of the identification information.

The terminal may receive the identification information from the base station. The terminal may determine whether each of the AI/ML models supported by the base station is supported by the terminal. The terminal may identify whether each AI/ML model included in the base station is applicable to communication between the terminal and the base station based on scenario/region information included in the identification information. The terminal may report, to the base station, first indication information indicating whether each of the AI/ML models supported by the base station is supported by the terminal or second indication information indicating whether each of the AI/ML models included in the base station is applicable (S920).

The base station may receive the first indication information or the second indication information from the terminal. The base station may transmit, to the terminal, third indication information indicating whether to activate each of the AI/ML models supported by or included in the base station based on the first indication information or the second indication information (S930). The third indication information may include information indicating a type of CSI feedback method performed by the terminal. For example, when the CSI feedback method performed by the terminal is a feedback method based on linear transformation, the third indication information may include information indicating a linear transformation matrix and a quantization scheme.

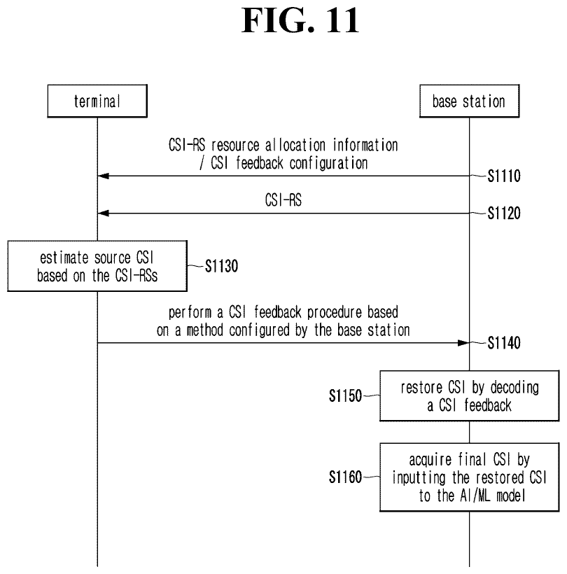

The procedures illustrated in FIG. 9 and FIG. 10 may be performed before the procedure illustrated in FIG. 11 is performed. In the exemplary embodiments illustrated in FIG. 9 through FIG. 11, a base station-side model may be assumed.

FIG. 10 is a sequence chart illustrating exemplary embodiments of a procedure for training an AI/ML model.

Referring to FIG. 10, the base station may transmit resource allocation information for transmission of CSI-RS for data pair collection and CSI reporting to the terminal (S1010). The base station may transmit CSI-RSs for data pair collection to the terminal and may transmit a CSI report request to the terminal (S1020). The CSI report request may include at least one of information on the number of data samples required for training the AI/ML model or a data sample period.

The terminal receiving the CSI report request may estimate CSI. The terminal may report the estimated CSI to the base station (S1030). The base station receiving the CSI report may acquire data pairs for training the AI/ML model based on the CSI report. The base station may train the AI/ML model based on the data pairs (S1040).

The data pair may vary depending on the functionality performed by the AI/ML model included in the base station. The data pair may have a form in which input data and target data are paired. When the AI/ML model included in the base station performs a functionality of predicting future CSI, the data pair required for training may include both source CSI at a current time point and CSI at a target future time point. When the AI/ML model included in the base station performs a functionality of predicting CSI in a target subband different from a subband in which source CSI is estimated, the data pair required for training may include both the source CSI and CSI in the target subband. When the AI/ML model included in the base station performs a functionality of restoring original CSI, the data pair required for training may include both the source CSI and the original CSI.

The AI/ML model included in the base station may perform a noise reduction functionality as an additional functionality. In order to perform the noise reduction functionality, high-resolution CSI may be required by the AI/ML model. The high-resolution CSI may refer to CSI estimated at many resource elements located on a resource grid. To acquire the high-resolution CSI, transmission of high-density CSI-RS may be required. The transmission of high-density CSI-RS may mean that CSI-RS is transmitted on more resource elements. The base station may transmit the high-density CSI-RS to the terminal and acquire both target CSI and high-resolution target CSI.

The base station may acquire past CSI as input data for training the AI/ML model that performs prediction of CSI at a future time point. For training the AI/ML model that performs prediction of CSI at a future time point, data pairs including both past CSI and current CSI may be acquired by the terminal. The past CSI data samples may be one or more.

FIG. 11 is a sequence chart illustrating exemplary embodiments of a CSI feedback procedure using a base station-side AI/ML model.

Referring to FIG. 11, the base station may transmit CSI-RS resource allocation information to the terminal (S1110). The base station may configure a CSI feedback method to be performed by the terminal (S1110). The base station may transmit CSI-RSs to the terminal (S1120). The terminal receiving the CSI-RSs may estimate source CSI based on the CSI-RSs (S1130). The terminal may feed back the source CSI to the base station using the method configured by the base station (S1140).

The base station receiving the CSI feedback from the terminal may decode the CSI feedback and restore CSI (S1150). The base station may input the received CSI to the AI/ML model included in the base station and acquire final CSI (S1160).

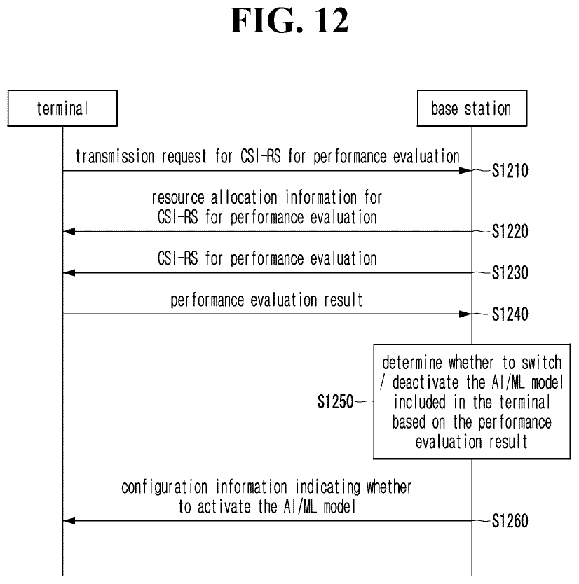

FIG. 12 is a sequence chart illustrating a first exemplary embodiment of a performance evaluation procedure for an AI/ML model.

Referring to FIG. 12, a terminal-side one-sided model may be assumed. The terminal may perform performance evaluation of the AI/ML model included in the terminal on its own. For performance evaluation of the AI/ML model, target data of the same type as training data corresponding to each functionality of the AI/ML model may be required. For example, when the AI/ML model included in the terminal performs a functionality of predicting future CSI, the target data required for performance evaluation may be CSI at a target future time point. When the AI/ML model included in the terminal performs a functionality of predicting CSI in a target subband different from the subband in which source CSI is estimated, the target data required may be CSI in the target subband. When the AI/ML model included in the terminal performs a functionality of restoring original CSI, the target data required may be original CSI.

The terminal may transmit a CSI-RS transmission request for performance evaluation to the base station (S1210). The CSI-RS transmission request for performance evaluation may be additionally transmitted when the terminal transmits a CSI-RS transmission request for acquiring source CSI.

The base station receiving the CSI-RS transmission request for performance evaluation may transmit resource allocation information for CSI-RS for performance evaluation to the terminal (S1220). When the performance evaluation is performed periodically, the resource allocation information for CSI-RS may include periodicity information. The base station may transmit CSI-RSs for performance evaluation to the terminal (S1230).

The terminal receiving the CSI-RSs for performance evaluation may estimate CSI based on the CSI-RSs. The estimated CSI may be used as target data samples for performance evaluation of the AI/ML model included in the terminal. The terminal having completed the performance evaluation may report a performance evaluation result to the base station (S1240). The base station receiving the performance evaluation result may determine whether to activate the AI/ML model included in the terminal based on the performance evaluation result (S1250). The base station may transmit, to the terminal, indication information indicating activation or deactivation of the AI/ML model included in the terminal according to the determination on whether to activate the AI/ML model (S1260). The terminal may receive the indication information indicating activation or deactivation of the AI/ML model included in the terminal from the base station. The terminal may determine whether to activate the AI/ML model included in the terminal based on the received indication information.

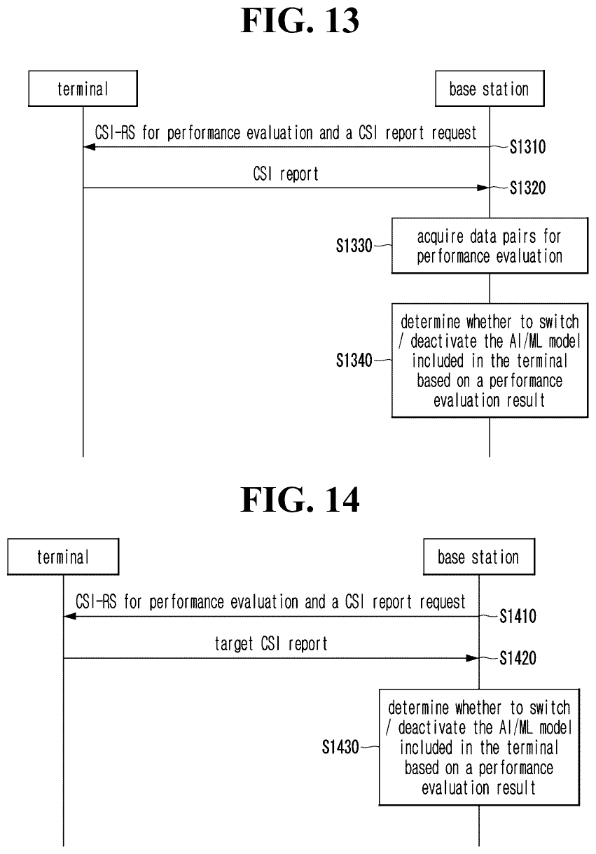

FIG. 13 is a sequence chart illustrating a second exemplary embodiment of a performance evaluation procedure for an AI/ML model.

Referring to FIG. 13, a base station-side one-sided model may be assumed. For performance evaluation of the AI/ML model, target data of the same type as training data corresponding to each functionality of the AI/ML model may be required. For example, when the AI/ML model included in the base station performs a functionality of predicting future CSI, the target data required for performance evaluation may be CSI at a target future time point. When the AI/ML model included in the base station performs a functionality of predicting CSI in a target subband different from a subband in which source CSI is estimated, the target data required may be CSI in the target subband. When the AI/ML model included in the base station performs a functionality of restoring original CSI, the target data required may be original CSI.

The base station may transmit CSI-RSs for performance evaluation to the terminal (S1310). The transmission of the CSI-RSs for performance evaluation may be additionally performed when the base station transmits CSI-RSs for the terminal to acquire source CSI. The base station may transmit a CSI report request to the terminal (S1310). The CSI reported in response to the CSI report request may be target data. The terminal receiving the CSI-RS may estimate CSI based on the CSI-RSs. The terminal may report the estimated CSI to the base station (S1320). The CSI reporting by the terminal may be additionally performed in addition to the CSI feedback that is the target of the performance evaluation.

The base station receiving the CSI report may acquire data pairs for performance evaluation of the AI/ML model included in the base station (S1330). Each of the data pairs may include final CSI and target CSI. To improve the accuracy of base station-side performance evaluation, acquisition of high-accuracy target data may be configured. When the terminal feeds back the target data, the terminal may use feedback of a larger size in terms of information amount compared to the existing CSI reporting.

The base station may evaluate the performance of the AI/ML model based on the data pairs. The base station may determine whether to activate the AI/ML model based on the performance evaluation result (S1340). The base station may notify the terminal of whether the AI/ML model included in the base station is to be activated.

FIG. 14 is a sequence chart illustrating exemplary embodiments of a performance evaluation procedure for an AI/ML model.

Referring to FIG. 14, a terminal-side one-sided model may be assumed. The base station may perform performance evaluation of the terminal-side AI/ML model. For performance evaluation of the AI/ML model, target data of a different type for each functionality of the AI/ML model may be required by the base station. For example, when the AI/ML model included in the terminal performs a functionality of predicting future CSI, future CSI may be required by the base station as target data samples. In order for the terminal to acquire CSI at a target future time point, the base station may transmit CSI-RS at the target future time point to the terminal.

When the AI/ML model included in the terminal performs a functionality of predicting CSI in a target subband different from a subband in which source CSI is estimated, CSI in the target subband may be required by the base station. In order for the terminal to acquire CSI in the target subband, the base station may transmit CSI-RSs to the terminal in the target subband.

When the AI/ML model included in the terminal performs a functionality of restoring original CSI from source CSI, the original CSI may be required by the base station as target data samples. In order for the terminal to acquire the original CSI, the base station may transmit CSI-RS to the terminal.

The base station may transmit CSI-RSs for performance evaluation to the terminal (S1410). The transmission of CSI-RSs for performance evaluation may be additionally performed when the transmission of CSI-RSs for acquiring source CSI by the terminal is performed. The base station may transmit a request for reporting target CSI to the terminal (S1410). The terminal receiving the CSI-RS may estimate target CSI and may report the estimated target CSI to the base station (S1420).

The base station receiving the reported target CSI may acquire data pairs for performance evaluation of the AI/ML model included in the terminal. The base station may perform performance evaluation of the AI/ML model included in the terminal using the data pairs. The base station may determine whether to change the AI/ML model included in the terminal or whether to activate the AI/ML model included in the terminal based on the performance evaluation result (S1430).

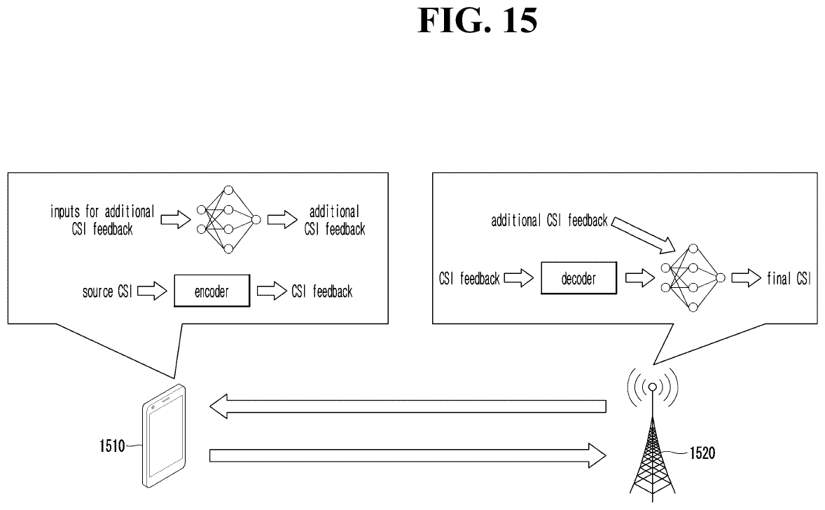

FIG. 15 is a conceptual diagram illustrating exemplary embodiments of a CSI feedback procedure using additional CSI feedback.

Referring to FIG. 15, a two-sided may be assumed. The terminal 1510 may perform interoperable encoding on source CSI estimated based on received CSI-RSs. The terminal 1510 may feed back existing CSI to the base station 1520 through the encoding. The terminal 1510 may input the source CSI to the AI/ML model and acquire additional CSI in addition to the existing CSI. The terminal 1510 may acquire the additional CSI based on channel state information at a current time point, channel state information at a past time point, or information on an environment to which the terminal 1510 belongs. The terminal 1510 may feed back the additional CSI to the base station 1520. The procedure in which the additional CSI is fed back may be referred to as an additional CSI feedback procedure.

The base station 1520 receiving the existing CSI and the additional CSI may perform interoperable decoding on the existing CSI. The base station 1520 may input the decoded existing CSI and the additional CSI to the AI/ML model included in the base station 1520. The base station 1520 may acquire final CSI from the AI/ML model.

The AI/ML model part included in the base station 1520 and the AI/ML model part included in the terminal 1510 may be interoperable. Identification information of the AI/ML model part included in the base station 1520 may include identification information of the AI/ML model part of the terminal 1510 with which interoperability is ensured. The type of input information or configuration information of the input information for the AI/ML model included in the terminal 1510 may be included in the identification information of the AI/ML model included in the terminal 1510. Configuration information of an additional CSI feedback message (e.g. length information of the additional CSI feedback message) may be predefined for each AI/ML model included in the terminal 1510. The configuration information of the additional CSI feedback message may be configured when CSI reporting is configured by the base station 1520. When the length information of the additional CSI feedback message is predefined for each AI/ML model included in the terminal 1510, the base station 1520 may omit the length information of the additional CSI feedback message when configuring CSI reporting for the terminal 1510.

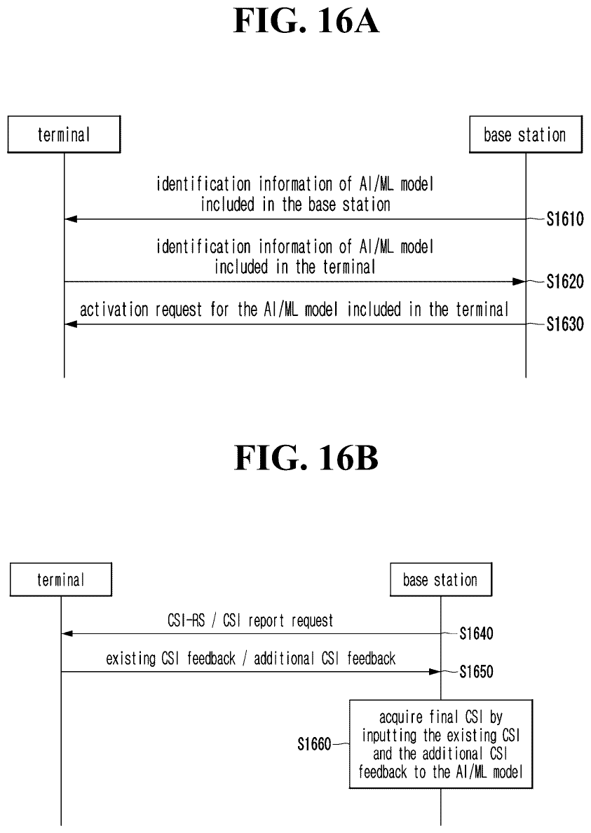

The operations described in the exemplary embodiment of FIG. 15 may be applied to FIGS. 16A and 16B.

FIG. 16A is a sequence chart illustrating exemplary embodiments of a CSI feedback procedure using additional CSI feedback.

Referring to FIG. 16A, a functionality of an AI/ML model included in the base station and the terminal may be a functionality of restoring original CSI. The functionality of the AI/ML model may be at least one of predicting future CSI, predicting CSI in a subband different from an estimated subband, or restoring original CSI. In the description of FIGS. 16A and 16B, the functionality of the AI/ML model may be assumed to be a functionality of restoring original CSI. However, to the extent that no technical inconsistency arises, the methods described in FIGS. 16A and 16B may also be applied to AI/ML models having different functionalities.

The base station may transmit identification information of the AI/ML model included in the base station to the terminal (S1610). When additional CSI is input to the AI/ML model included in the base station, the identification information of the AI/ML model included in the base station may include identification information of the AI/ML model included in the terminal.

The terminal receiving the identification information of the AI/ML model included in the base station may transmit identification information of the AI/ML model included in the terminal to the base station (S1620). The base station receiving the identification information of the AI/ML model included in the terminal may transmit an activation request for the AI/ML model included in the terminal to the terminal (S1630).

FIG. 16B is a sequence chart illustrating exemplary embodiments of a CSI feedback procedure using additional CSI feedback.

Referring to FIG. 16B, the base station may transmit CSI-RS to the terminal (S1640). The base station may transmit a CSI report request to the terminal (S1640). The terminal receiving the CSI-RS may estimate source CSI. The terminal may acquire existing CSI through an inter-operable encoding procedure based on the source CSI. The terminal may input the source CSI to the AI/ML model and acquire additional CSI. Past source CSI and current CSI may be considered as inputs to the AI/ML model. The terminal may feed back the existing CSI and the additional CSI to the base station (S1650).

The base station receiving the existing CSI and the additional CSI may perform an interoperable decoding procedure on the existing CSI. The base station may input the decoded CSI and the additional CSI to the AI/ML model included in the base station. The base station may acquire final CSI from the AI/ML model (S1660). The final CSI may be the original CSI of the source CSI.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a channel state information (CSI)-reference signal (RS) from a base station;
estimating source CSI between the base station and the terminal based on the CSI-RS;
inputting the source CSI into an artificial intelligence (AI)/machine learning (ML) model included in the terminal to acquire original CSI of the source CSI; and
performing a feedback procedure for the original CSI using an interoperable CSI feedback method between the base station and the terminal.

2. The method according to claim 1, further comprising:
before receiving the CSI-RS, transmitting identification information of one or more AI/ML models supported by the terminal to the base station;
in response to the identification information, receiving, from the base station, configuration information for configuring an original CSI restoration AI/ML model that performs an original CSI restoration functionality in the terminal; and
configuring the original CSI restoration AI/ML model among the one or more AI/ML models in the terminal according to the configuration information.

3. The method according to claim 1, wherein the performing of the feedback procedure for the original CSI further comprises:
determining a similarity between each of matrixes defined based on a codebook included in both the terminal and the base station and the original CSI;
determining index information associated with a matrix corresponding to the original CSI based on the similarities; and
transmitting the index information to the base station to feed back the original CSI.

4. The method according to claim 1, further comprising:
before receiving the CSI-RS, transmitting a request for CSI transmission for data pair collection to the base station;
in response to the request for CSI-RS transmission, periodically receiving one or more CSI-RSs for data pair collection from the base station;
collecting one or more data samples based on the one or more CSI-RSs for data pair collection to acquire data pairs for training the AI/ML model; and
training the AI/ML model based on the data pairs.

5. The method according to claim 1, further comprising:
transmitting a request for CSI-RS transmission for performance evaluation of the AI/ML model to the base station;
in response to the request for CSI-RS transmission, periodically receiving one or more CSI-RSs for performance evaluation from the base station;
collecting one or more data samples based on the one or more CSI-RSs for performance evaluation to acquire data pairs for performance evaluation of the AI/ML model; and
evaluating a performance of the AI/ML model based on the data pairs and reporting a performance evaluation result to the base station.

6. The method according to claim 5, further comprising:
in response to the performance evaluation result, receiving, from the base station, indication information indicating whether to deactivate the AI/ML model; and
determining whether to deactivate the AI/ML model according to the indication information.

7. A method of a base station, comprising:
transmitting a channel state information (CSI)-reference signal (RS) to a terminal;
receiving, from the terminal, a feedback on original CSI generated by an artificial intelligence (AI)/machine learning (ML) model included in the terminal;
performing an interoperable CSI decoding procedure on the feedback on the original CSI; and
restoring the original CSI through the interoperable CSI decoding procedure.

8. The method according to claim 7, wherein the performing of the interoperable CSI decoding procedure comprises:
receiving index information associated with the original CSI included in the received feedback; and
determining a matrix corresponding to the index information as CSI among matrixes defined based on a codebook commonly defined for the terminal and the base station.

9. The method according to claim 8, further comprising:
before transmitting the CSI-RS, receiving, from the terminal, identification information of one or more AI/ML models supported by the terminal; and
in response to the identification information, transmitting, to the terminal, configuration information for configuring an original CSI restoration AI/ML model that performs an original CSI restoration functionality in the terminal.

10. The method according to claim 8, further comprising:
receiving, from the terminal, a request for CSI transmission for data pair collection; and
in response to the request for CSI-RS transmission, periodically transmitting CSI-RSs for data pair collection to the terminal,
wherein the data pairs are used to train the AI/ML model included in the terminal.

11. The method according to claim 8, further comprising:
receiving, from the terminal, a request for CSI-RS transmission for performance evaluation of the AI/ML model included in the terminal;
in response to the request for CSI-RS transmission, periodically transmitting one or more CSI-RSs for performance evaluation to the terminal;
receiving, from the terminal, a performance evaluation result generated by the terminal based on the one or more CSI-RSs for performance evaluation; and
determining whether to activate the AI/ML model based on the performance evaluation result.

12. A terminal comprising at least one processor, wherein the at least one processor causes the terminal to perform:
receiving a channel state information (CSI)-reference signal (RS) from a base station;
estimating source CSI between the base station and the terminal based on the CSI-RS;
inputting the source CSI into an artificial intelligence (AI)/machine learning (ML) model included in the terminal to acquire original CSI of the source CSI; and
performing a feedback procedure for the original CSI using an interoperable CSI feedback method between the base station and the terminal.

13. The terminal according to claim 12, wherein the at least one processor further causes the terminal to perform:
before receiving the CSI-RS, transmitting identification information of one or more AI/ML models supported by the terminal to the base station;
in response to the identification information, receiving, from the base station, configuration information for configuring an original CSI restoration AI/ML model that performs an original CSI restoration functionality in the terminal; and
configuring the original CSI restoration AI/ML model among the one or more AI/ML models in the terminal according to the configuration information.

14. The terminal according to claim 12, wherein in the performing of the feedback procedure for the original CSI, the at least one processor causes the terminal to perform:
determining a similarity between each of matrixes defined based on a codebook included in both the terminal and the base station and the original CSI;
determining index information associated with a matrix corresponding to the original CSI based on the similarities; and
transmitting the index information to the base station to feed back the original CSI.

15. The terminal according to claim 12, wherein the at least one processor further causes the terminal to perform:
before receiving the CSI-RS, transmitting a request for CSI transmission for data pair collection to the base station;
in response to the request for CSI-RS transmission, periodically receiving one or more CSI-RSs for data pair collection from the base station;
collecting one or more data samples based on the one or more CSI-RSs for data pair collection to acquire data pairs for training the AI/ML model; and
training the AI/ML model based on the data pairs.

16. The terminal according to claim 12, wherein the at least one processor further causes the terminal to perform:
transmitting a request for CSI-RS transmission for performance evaluation of the AI/ML model to the base station;
in response to the request for CSI-RS transmission, periodically receiving one or more CSI-RSs for performance evaluation from the base station;
collecting one or more data samples based on the one or more CSI-RSs for performance evaluation to acquire data pairs for performance evaluation of the AI/ML model; and
evaluating a performance of the AI/ML model based on the data pairs and reporting a performance evaluation result to the base station.

17. The terminal according to claim 16, wherein the at least one processor further causes the terminal to perform:
in response to the performance evaluation result, receiving, from the base station, indication information indicating whether to deactivate the AI/ML model; and
determining whether to deactivate the AI/ML model according to the indication information.
